(19) United States
(12) Patent Application Publication
(10) Pub. No.: US 2024/0077175 A1
(43) Pub. Date: Mar. 7, 2024

(54) BOSS-LINER STRUCTURE FOR A TYPE IV PRESSURE VESSEL

(71) Applicant: AMS Belgium, Bilzen (BE)

(72) Inventor: Johan Potargent, Bilzen (BE)

(73) Assignee: AMS Belgium, Bilzen (BE)

(21) Appl. No.: 18/280,383

(22) PCT Filed: Mar. 4, 2022
(86) PCT No.: PCT/IB2022/051934

§ 371 Date: Sep. 5, 2023

(30) Foreign Application Priority Data
Mar. 9, 2021 (BE) 2021/5176

(51) Int. Cl. F17C 1/16

(52) U.S. Cl. CPC F17C 1/16; F17C 2201/0109; F17C 2203/0604; F17C 2205/0305

(57) ABSTRACT

The present invention concerns a device for storing a pressurized gaseous or liquid medium. The invention relates to a device for storing a pressurized gaseous or liquid medium. The invention further relates to a method for manufacturing such a device.

The present invention concerns a device for storing a pressurized gaseous or liquid medium. The invention relates to a device for storing a pressurized gaseous or liquid medium, of the kind specified in the preamble of claim 1. The invention further relates to a method for manufacturing such a device.

### PRIOR ART

As part of a future energy mix that draws substantially from renewable energy sources (solar, wind, hydropower), gases, such as hydrogen, offer a solution for improved, more flexible power grids. In addition, manufacturers increasingly rely on systems using CNG and hydrogen as an alternative propulsion technology for heavy and light vehicles.

Devices for storing such gases are known in general from the art. Pressure vessels are typically used for storing a variety of liquids under pressure, such as for example for storing oxygen, natural gas, nitrogen, hydrogen, propane and other fuels.

Typically, such pressure vessels are divided into different types. A so-called type II pressure vessel is a pressure vessel provided with an inner container, the so-called liner, made of high-grade steel or stainless steel, and an outer shell surrounding this inner container, for example made of fiber reinforced material. A type III pressure vessel has an aluminum liner and a type IV pressure vessel typically has a liner of a plastic material, such as high density polyethylene (HDPE), surrounded by at least one outer casing of fiber reinforced plastic material. Such pressure vessels serve as devices for storing gases—or liquids—under high pressures. In general, they serve to store the largest possible amount of gas in a relatively manageable volume of the device at pressures in the order of about 350 bar, in the order of about 700 bar or in the order of 1100 to 1200 bar, particularly for light gases such as hydrogen.

Type IV pressure vessels or tanks have a metal-free body that typically comprises a carbon fiber reinforced polymer composite, wrapped and/or braided over a thermoplastic polymeric liner. Suitable pressure vessel materials comprise laminated layers of wrapped glass fiber filaments or other synthetic filaments which are bonded together by a thermal curing or thermoplastic resin. An elastomeric or other non-metal resilient liner is placed inside the composite casing to seal the vessel and to prevent liquids within from contacting the composite material. The composite construction of the vessels offers numerous advantages, such as lightness in weight and resistance to corrosion, fatigue and catastrophic failure. These properties are due to the high specific strength of the reinforcing fibers or filaments, which are typically oriented in the direction of the major forces in the construction of the pressure vessels.

Each vessel has a valve coupled thereto for filling the vessel with compressed liquid. However, the valve cannot be directly connected to the polymer liner. For this reason, a boss needs to be provided for coupling the valve to the vessel.

### AIM OF THE INVENTION

An aim of the invention may be to provide a stable and integrated interface between boss and liner, for example to prevent blow outs and/or accumulations of gas between the boss and liner.

A further aim of the invention may be to provide a boss-liner structure showing improved resistance against expansion or contraction.

Another aim of the invention may be to provide a method for forming such a boss-liner structure.

### DESCRIPTION OF THE INVENTION

This aim is achieved according to the invention by a method showing the technical characteristics of the first independent claim.

In a first aspect of the invention, which can occur in combination with the other aspects and embodiments of the invention described herein, the invention comprises a method for the production, by means of rotational molding, of a boss-liner structure for a type IV pressure vessel from a material containing a curable raw material.

The method comprises providing a mold, for forming a liner comprising a hollow body defined by an elongated cylindrical liner wall having opposed inner and outer surfaces extending between a first end and a second end of the liner,
wherein the cylindrical liner wall comprises a cylindrical main portion, a rounded head portion and a cylindrical neck, wherein the cylindrical liner wall has a passage opening near the first end of the liner, wherein the passage opening is determined by an edge of the liner, and
providing a boss having a boss bore extending axially through the boss, wherein the boss bore is determined by a cylindrical wall having an inner surface, and a flange projecting radially outward having inner and outer flange surfaces located opposite to each other,
wherein the boss is arranged so that the boss bore at least partially extends into an interior of the mold, and so that the outer flange surface faces the inner surface of the mold.

The method further comprises providing a sealing element in the boss bore through the boss; filling a mold cavity in the mold with the material; heating the material to a first predetermined temperature; rotating the mold so that the liner is formed from the material, wherein the liner is formed at the inner and outer sides of the flange and in the bores or recesses; and cooling the formed liner to a second predetermined temperature.

Due to the presence of the boss, particularly the flange of the boss, in the interior of the mold during the production of the liner by rotational molding, the boss is easily integrated and centered in the liner. Moreover, a well-sealed structure is formed due to the liner being formed at the inner and outer sides of the flange. Furthermore, the boss is secured against axial rotation relative to the liner by the anchors, i.e., parts of the formed liner extending in the bores or recesses of the flange.

Thus, at least one of the following traditional processing steps may be omitted: drilling out, deburring and removing all dirt from the zone of the liner where the boss is to be provided, applying a seal, mounting the boss and then cleaning up the structure again.

In a first embodiment according to the invention, which can occur in combination with the other aspects and embodiments of the invention described herein, the sealing element extends only partially into the boss bore so that the liner formed while rotating the mold extends partially into the boss bore. In a further embodiment according to the invention, the sealing element may be provided with a substantially semicircular end part facing the interior of the mold and arranged in such a way that, in an axial direction of the boss bore through the boss, the axial position of the inner side of the neck of the boss corresponds to the axial position of a point of the semicircular end part.

By partially covering the inner side of the wall surrounding the boss bore, or by integrating it into the liner, a good sealing can be provided up to a connecting element, for example a valve, that is connected to the boss, for example by means of a thread. As a result, the structure or the pressure vessel will suffer less from expansion or contraction.

In a second embodiment according to the invention, which can occur in combination with the other aspects and embodiments of the invention described herein, the mold is defined by an elongated cylindrical mold wall having an inner surface that extends between a first end and a second end of the mold, wherein the mold wall comprises a cylindrical main portion, a rounded head portion and an opening near the first end of the mold, wherein the boss is arranged so that the boss bore extends through the opening in the mold and is in fluid communication with the interior of the mold, and so that the outer flange surface faces the inner surface of the mold. In a further embodiment according to the invention, the mold wall may comprise a second opening near the second end of the mold.

In a third embodiment according to the invention, which can occur in combination with the other aspects and embodiments of the invention described herein, the mold is provided with a second opening in a second front end and the method further comprises providing a second boss having a boss bore extending axially through the second boss, wherein the boss bore is determined by a cylindrical wall having an inner surface, and a second flange projecting radially outward having inner and outer flange surfaces located opposite to each other, wherein the second boss is arranged so that the boss bore extends into an interior of the mold, and so that the outer flange surface faces the inner surface of the mold, and providing a second sealing element in the boss bore through the second boss. In a further embodiment according to the invention, the boss and the second boss may be facing away from each other.

In a second aspect of the invention, which can occur in combination with the other aspects and embodiments of the invention described herein, the invention comprises a boss-liner structure for a type IV pressure vessel. The structure comprises a polymeric, preferably thermoplastic, liner, comprising a hollow body defined by an elongated cylindrical liner wall having opposed inner and outer surfaces extending between a first end and a second end of the liner. The cylindrical liner wall comprises a cylindrical main portion, a rounded head portion and a cylindrical neck, wherein the cylindrical liner wall has a passage opening near the first end of the liner, wherein the passage opening is determined by an edge of the liner. The structure further comprises a boss having a boss bore extending axially through the boss, wherein the boss bore is determined by a cylindrical wall having an inner surface, wherein the boss bore is in fluid communication with an interior of the pressure vessel.

The boss comprises a flange having inner and outer flange surfaces located opposite to each other, wherein the inner flange surface faces the inner surface of the liner and the outer flange surface faces the outer surface of the liner, wherein the flange is integrated in the cylindrical neck of the cylindrical wall. In an embodiment according to the invention, which can occur in combination with the other aspects and embodiments of the invention described herein, the flange is integrated in a monolithic layer of the cylindrical neck.

In a third aspect of the invention, which can occur in combination with the other aspects and embodiments of the invention described herein, the invention comprises a pressure vessel configured for storing a pressurized fluid, comprising a boss-liner structure manufactured as described above or a boss-liner structure as described above, and an outer composite shell, wherein the outer composite shell surrounds an outer perimeter of the liner. In an embodiment according to the invention, which can occur in combination with the other aspects and embodiments of the invention described herein, said outer composite shell is formed by braiding a number of strands of fiber around at least part of an outer perimeter of said liner.

### BRIEF DESCRIPTION OF THE FIGURES

The invention will hereafter be further elucidated by reference to an exemplary embodiment shown in the drawings.

FIG. 1 shows a schematic view of a pressure vessel according to an embodiment of the present invention;

FIG. 2 shows an exploded view of a boss and liner structure according to a first embodiment of the present invention for the pressure vessel shown in FIG. 1;

FIG. 3 shows an exploded view of a boss and liner structure according to a second embodiment of the present invention for the pressure vessel shown in FIG. 1; and

FIG. 4 shows an exploded view of a boss and liner structure according to a third embodiment of the present invention for the pressure vessel shown in FIG. 1.

### DETAILED DESCRIPTION OF THE FIGURES

The present invention will hereafter be described with respect to particular embodiments and with reference to certain drawings, but the invention is not limited thereto and is defined only by the claims. The drawings described are merely schematic depictions and are non-limiting. In the drawings, the dimensions of certain parts may be exaggerated, and not drawn to scale, for illustrative purposes. The dimensions and the relative dimensions do not necessarily correspond to the actual reductions to practice of the invention.

Furthermore, the terms “first”, “second”, “third” and the like are used in the description and in the claims for distinguishing between similar elements, and not necessarily for describing a sequential or chronological order. The terms in question are interchangeable under the appropriate circumstances and the embodiments of the invention may be carried out in other sequences than described or illustrated here.

Moreover, the terms “top”, “bottom”, “over”, “under” and the like are used in the description and the claims for descriptive purposes and not necessarily for indicating relative positions. The terms so used are interchangeable under the appropriate circumstances, and the embodiments of the invention may be carried out in other orientations than those described or illustrated herein.

Furthermore, the different embodiments, although referred to as “preferred forms”, should rather be understood by way of example, as ways in which the invention may be carried out, and not as limiting the scope of the invention.

The term “comprising”, as used in the claims, should not be interpreted as being restricted to the means or steps listed thereafter; the term does not exclude other elements or steps. The term should be interpreted as specifying the presence of said features, elements, steps or components as referred to, without, however, precluding the presence or addition of one or more additional features, elements, steps or components, or groups thereof. Thus, the scope of the expression “a device comprising means A and B” should not be limited to devices consisting only of components A and B. What is meant is that with respect to the present invention, only the components A and B are listed, and the claim should further be interpreted as also comprising equivalents of those components.

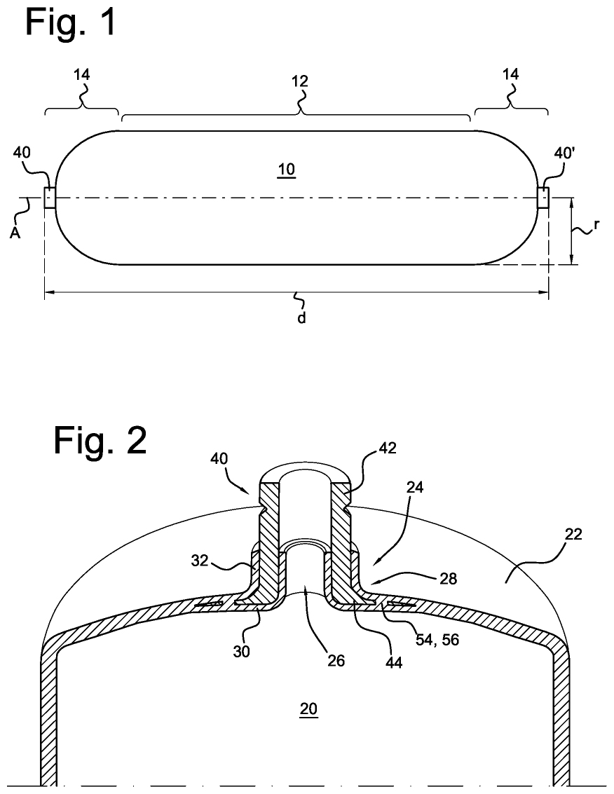

FIG. 1 shows an elongated pressure vessel 10, having a main portion 12 and end portions 14, cylindrically shaped with a radius and extending over a length d between both ends of the pressure vessel 10. A metal boss 30 is arranged at one or both ends of the pressure vessel 10 so as to provide a port for communicating with the interior of the pressure vessel 10. The pressure vessel 10 is formed by an inner (thermoplastic) polymeric liner 20 covered by an outer composite shell. In this case, “composite” refers to a fiber reinforced resin matrix material, such as a fiber wrapped or laminated structure. The pressure vessel 10 according to the present invention may be manufactured for storing about one liter, two liters, three liters, five liters, eight liters, thirteen liters, twenty-one liters, thirty-four liters, fifty-five liters and other suitable amounts of hydrogen. FIGS. 2-4 show details of improved boss and liner structures for a pressure vessel. The liner 20 has a generally cylindrical shape having a substantially semicircular end section 22 with a neck-shaped end section 24. The neck-shaped end section 24 comprises a passage 26 adapted for being aligned within an opening in the outer composite shell, and a hollow wall 28 surrounding the passage. The hollow wall 28 comprises an inner annular wall part 30 and an outer annular wall part 32.

The liner 20 according to the present invention may be manufactured from any material available to the person skilled in the art. Suitable materials may for example be selected from thermosetting (co)polymers such as epoxides, unsaturated polyester resins and the like. Suitable thermoplastic (co)polymers are for example polyamides (PA), polyolefins, for example polypropene (PP), polyethene (PE), polytetrafluoroethylene (PTFE), polyphenylene ether (PPE or PPO), etcetera, amorphous and/or crystalline polyesters such as polyalkylene terephthalates, for example polyethene terephthalate (PETP or PET), polybutene terephthalate (PBT), etc., or polyimides (PI), such as for example polyetherimide (PEI), polyamide-imide (PAI), or polymethyl(meth)acrylate (PMMA), polyether methacrylate (PEMA), and polycarbonates.

The boss 40 extends in the hollow wall 28 of the neck-shaped end section 24 and comprises a neck 42 and flange 44 projecting radially outward. The neck 42 defines a passage 44 aligned with the passage 26 of the liner 20, allowing high-pressure fluid to be communicated to the interior of the pressure vessel 10. The flange 44 has an inner side 46 and an outer side 48. A bottom opening 50 is defined at the inner side of the flange 44. The bottom opening is connected to an upper opening 52 at the outer side of the flange 44 by means of a number of discrete bores 54. The bores 54 may for example be circular or elongated in cross section.

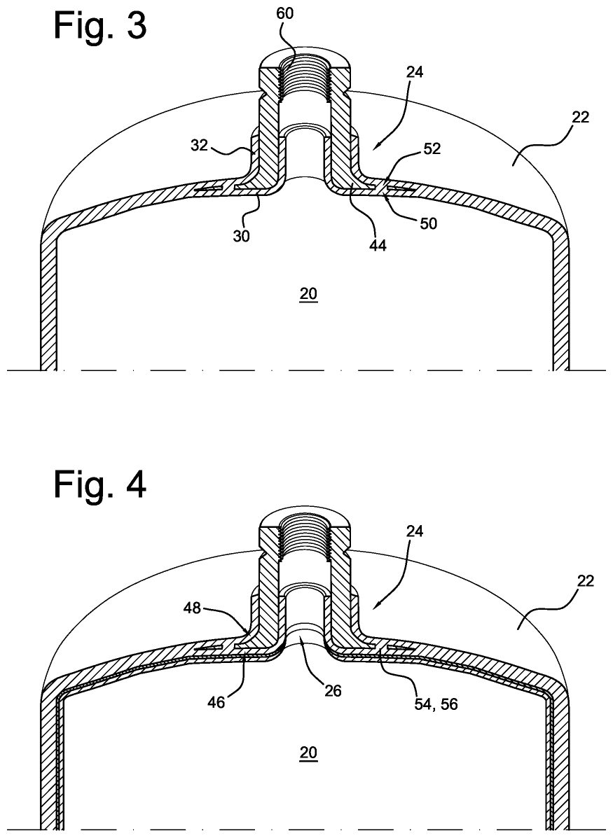

FIGS. 2 and 3 show the boss-liner structure provided with a thread 60 on the inner surface of the neck 42. FIG. 3 further shows a layered liner 20 consisting of several layers of at least two different materials. In the embodiment shown, the inner and outer monolithic layers are manufactured from the same material, which is preferably molded by rotational molding. In the embodiment shown, the flange is integrated in the outer layer.

A method for connecting the liner 20 and the boss 40 comprises allowing a liquid polymer material for the liner 20 to flow at the inner and outer sides 46, 48 of the flange 44 and into the bores 54 so as to fill these. After solidifying, the liner material forms an anchor 56 in the bores 54. The liner 20 is mechanically interlocked with the boss 40 by the anchors 56 formed in the bores 54, which in this embodiment connect the liner material at the inner side 30 to the liner material at the outer side 32. Alternatively, a “bore” does not need to extend all the way through a member. As such, the bore 54 may extend from its openings 50, 52 to a closed end thereof. In both embodiments, separation of the liner 20 from the boss 40 is prevented even under extreme pressure circumstances.

A method for forming a pressure vessel 10 comprises inserting a boss 40 into het front part of a mold. The protruding part of the boss is secured at the outer side of the mold so that the boss can no longer move. The boss is positioned in such a way in het front part of the mold that liner material may come between the mold and the boss (i.e., at the outer side of the boss). Further, the boss receives a sealing means provided with an air-permeable filter or Teflon plastic membrane extending through the boss and ensuring that no material can fall out of the mold, and also ensuring that a liner layer can adhere to the inner side of the boss. As a result, the boss is completely surrounded in the mold, both at the inner and at the outer side, so that that no further membrane sealing is required.

By placing the boss in the mold, the boss is centered and attached to the liner in a single step, with a complete sealing at the inner and outer sides of the flange of the boss. As a result, production is simplified, as it is no longer necessary to carry out the successive steps of drilling an opening into the liner for receiving the boss, cleaning the elements, applying a (membrane) seal, mounting the boss and cleaning the tank again.

### REFERENCE LIST

10. Pressure vessel
12. Main portion of the pressure vessel
14. End portions of the pressure vessel
20. Liner
22. Semicircular end section
24. Neck-shaped end section
26. Passage through the Neck-shaped end section
28. Hollow Wall of the Neck-shaped end section
30. Inner annular wall part of the Hollow Wall
32. Outer annular wall part of the Hollow Wall
40. Boss
42. Neck of the Boss
44. Flange of the Boss
46. Inner side of the Flange
48. Outer side of the Flange
50. Opening at the Inner side of the Flange
52. Opening at the Outer side of the Flange
54. Bore through the Flange
56. Anchor in the Bore
60. Thread

1. Method for the production, by means of rotational molding, of a boss-liner structure for a type IV pressure vessel from a material containing a curable raw material, comprising the steps of:
providing a mold, for forming a liner having a hollow body defined by an elongated cylindrical liner wall having opposed inner and outer surfaces extending between a first end and a second end of the liner, wherein the cylindrical liner wall comprises a cylindrical main portion, a rounded head portion and a neck-shaped end section cylindrical, wherein the cylindrical liner wall has a passage opening near the first end of the liner, wherein the passage opening is determined by an edge of the liner;
providing a boss having a boss bore extending axially through the boss, wherein the boss bore is determined by a cylindrical wall having an inner surface, and a flange projecting radially outward having inner and outer flange surfaces located opposite to each other, wherein the boss is arranged so that the bore at least partially extends into an interior of the mold, and so that the outer flange surface faces the inner surface of the mold;
providing a sealing element in the boss bore through the boss;
filling a mold cavity in the mold with a first thermoplastic material;
heating the material to a first predetermined temperature;
rotating the mold so that an outer monolithic layer of the liner is formed from the first thermoplastic material, wherein the liner is formed at the inner and outer sides of the flange and in the bores or recesses and wherein the flange is integrated into the outer monolithic layer forming at least one further layer of the liner inside the outer monolithic layer, such that the liner is a layered liner consisting of a plurality of monolithic layers of at least two different thermoplastic materials; and
cooling the formed liner to a second predetermined temperature.

2. Method according to claim 1, wherein the sealing element extends only partially into the boss bore so that the liner formed while rotating the mold extends into the passage through the boss.

3. Method according to claim 1, wherein the sealing element is provided with a substantially semi-circular end part facing the interior of the mold and arranged in such a way that the axial position of the inner side of the neck of the boss corresponds to the axial position of a point of the semi-circular end part.

4. Method according to claim 1, wherein the mold is defined by an elongated cylindrical mold wall having an inner surface that extends between a first end and a second end of the mold, wherein the mold wall comprises a cylindrical main portion, a rounded head portion and an opening near the first end of the mold, wherein the boss is arranged so that the boss bore extends through the opening in the mold and is in fluid communication with the interior of the mold, and so that the outer flange surface faces the inner surface of the mold.

5. Method according to claim 1, wherein the mold wall comprises a second opening near the second end of the mold.

6. Method according to claim 1, wherein the mold is provided with a second opening in a second front end and the method further comprises:
providing a second boss having a boss bore extending axially through the second boss, wherein the boss bore is determined by a cylindrical wall having an inner surface, and a second flange projecting radially outward having inner and outer flange surfaces located opposite to each other, wherein the second boss is arranged so that the boss bore extends into an interior of the mold, and so that the outer flange surface faces the inner surface of the mold; and
providing a second sealing element in the boss bore through the second boss.

7. Method according to claim 1, wherein the boss and the second boss are facing away from each other.

8. Boss-liner structure for a type IV pressure vessel, comprising:
a thermoplastic liner comprising a hollow body defined by an elongated cylindrical liner wall having opposed inner and outer surfaces extending between a first end and a second end of the liner, wherein the cylindrical liner wall comprises a cylindrical main portion, a rounded head portion and a neck-shaped end section, wherein the cylindrical liner wall has a passage opening near the first end of the liner, wherein the passage opening is determined by an edge of the liner; and
a boss having a boss bore extending axially through the boss, wherein the boss bore is determined by a cylindrical wall having an inner surface, wherein the boss bore is in fluid communication with an interior of the pressure vessel; wherein the boss has a flange having inner and outer flange surfaces located opposite to each other, wherein the inner flange surface faces the inner surface of the liner, and the outer flange surface faces the outer surface of the liner, wherein the flange is integrated in the neck-shaped end section of the cylindrical wall, wherein the liner is a layered liner consisting of a plurality of monolithic layers of at least two different thermoplastic materials and wherein the flange is integrated in the outer monolithic layer.

9. (canceled)

10. Boss-liner structure according to claim 8, wherein the boss is provided with a thread on the inner surface of the cylindrical wall.

11. (canceled)

12. Boss-liner structure according to claim 9, wherein the flange is integrated in the outer monolithic layer.

13. Pressure vessel configured for storing a pressurized fluid, comprising:
a boss-liner structure manufactured according to claim 1 or a boss-liner structure according to claim 9; and
an outer composite shell, wherein the outer composite shell surrounds an outer perimeter of the liner.

14. Pressure vessel according to claim 13, wherein said outer composite shell is formed by braiding a number of strands of fiber around at least part of an outer perimeter of said liner.
